(19) United States
(12) Patent Application Publication
(10) Pub. No.: US 2003/0175028 A1
(43) Pub. Date: Sep. 18, 2003

(54) Method and apparatus for hitlessly accessing a data signal using a signaling protocol

(76) Inventors: Kapil Shrikhande, Menlo Park, CA (US); Yoshiaki Ikoma, Tokyo (JP); Kazuyoshi Horie, Tokyo (JP)

Correspondence Address: BEYER WEAVER & THOMAS LLP, P.O. BOX 778, BERKELEY, CA, 94704-0778, US

(21) Appl. No.: 10/099,534

(22) Filed: Mar. 15, 2002

Related U.S. Application Data
(60) Provisional application No. 60/364,562, filed on Mar. 13, 2002.
(60) Provisional application No. 60/364,994, filed on Mar. 14, 2002.

(51) Int. Cl. H04J 14/00; H04B 10/20

(52) U.S. Cl. 398/83; 398/48

(57) ABSTRACT

Methods, apparatus and techniques for hitlessly accessing an original data signal include provisioning a duplicate of the original signal at a provisioning location. The duplicate signal is sent to a switching location that has been transmitting the original signal, but which hitlessly switches to transmitting the duplicate signal instead. The original signal is accessed at an access location where the original signal is altered. The altered signal is sent to the switching location which again hitlessly switches from transmitting the duplicate signal to transmitting the altered signal. Implementation in an optical network allows wavelengths to be dropped at nodes in the network without network hits being incurred which would disrupt service or otherwise result in system downtime.

### CROSS-REFERENCE TO RELATED APPLICATION

This application claims the benefit of U.S. Provisional No. ______ (Attorney Docket No. STFUP020P) filed on Mar. 14, 2002, the disclosure of which is incorporated herein by reference.

### BACKGROUND OF THE INVENTION

1. Field of the Invention

This invention relates generally to methods, systems and apparatus for managing data transmission networks. More specifically, this invention relates to hitlessly accessing data signals, including performing add-drop functions, especially in optical data transmission systems.

2. Description of Related Art

The present invention applies to data transmission systems, including (but not limited to) systems using carriers to carry modulated signals containing data on any of a variety of transmission media (for example, optical fiber). The term “carriers” is defined broadly here to indicate the energy used to carry and transmit data in a timed fashion (for example, light, electricity and radio waves). Data and other aspects of these carriers can be removed, added and/or altered at various locations in a data transmission system. The present invention can be implemented at various locations in such a system. For purposes of illustration and to present examples and various embodiments of the present invention, an optical system is used and discussed. In optical systems, data is transmitted using light (one type of carrier) via modulated light signals that can be “dropped” and altered at various nodes and/or other network elements in the network (which are specific “locations”).

It is becoming increasingly important to build networks that allow easy and frequent access to bandwidth at fine granularity (for example, at the level of TDM channels, frames and packets). The word “access” includes, but is not limited to, circuit provisioning, monitoring, cross-connecting and routing.

Consider the wavelength add-drop operation of FIG. 1. In FIG. 1A, node 100 retimes, regenerates and reshapes (“3Rs”) wavelength λ3 from fiber 105 while OADM 110 lets λ0 pass transparently. Assume that λ0 and λ3 are partially empty and hence can be used for TDM channel provisioning. To access a TDM channel on λ3, node 100 needs to locate the channel's timing within the received frame. But when a node drops a wavelength such as λ0 to access a TDM channel, as shown in FIG. 1B, node 100 needs to drop λ0, synchronize its equipment with upstream and downstream nodes and then resume data transmission. With current OADM architectures and add-drop techniques, all services on λ0 are disrupted while the above tasks are performed, resulting in downtime or a “hit” for all TDM channels on λ0.

Current standards allow a hit of less than 50 ms during reconfiguration, such as an add-drop. While a hit is considered acceptable for infrequent add-drops (for example, a few times a month) and/or at low utilization levels, it may be unacceptable for networks being built for high levels of reconfigurability.

Hitless add-drop techniques allow more frequent access TDM channels for a variety of reasons (for example, capacity upgrade and downgrade, load balancing by rearranging TDM channels), regardless of utilization levels. Hitless access to TDM channels also can provide a means for non-disruptive monitoring. It permits hard quality of service guarantees to customers. Moreover, a hitless operation can be important for higher bit-rates, since downtime results in a corresponding loss of bits.

Earlier systems and techniques permitted hitless service, but with certain design constraints and performance limitations. Some of these earlier systems and techniques 3R all wavelengths at all nodes, in which case provisioning a TDM channel does not require add-drop and synchronization; thus these systems are hitless. Although, straightforward, this requires optical/electrical and electrical/optical conversions for all wavelengths which is costly. Another technique provisions an unused wavelength for each request. This is not efficient in terms of resource utilization. One or more methods also exist for hitlessly performing add-drops in an all-optical environment, however these methods likewise suffer from various shortcomings.

As can be appreciated, high reconfigurability in data transmission systems will result in more frequent hits that can significantly degrade the quality of service provided to users. Earlier attempts to address this problem have been costly and/or required inefficient use of system resources. Thus, there is a need to provide apparatus, methods and/or techniques to perform hitless add-drops on data signals that are more economical and efficient.

### BRIEF SUMMARY OF THE INVENTION

Broadly speaking, the present invention includes methods, apparatus and techniques for hitlessly accessing data signals in a data transmission system. Such access can include add-drops of wavelengths and other carriers transmitting data in a data transmission system, such as an optical network. The present invention is useful in a variety of transmission systems and can be used to assist in circuit provisioning, monitoring, cross-connecting and routing. The invention can be implemented in numerous ways, including (without limitation) as a method, network element, network segment or other system.

In one embodiment, the invention relates to a method of hitlessly accessing an original signal which includes provisioning a duplicate of the original signal at a provisioning location. The duplicate signal is sent to a switching location that has been transmitting the original signal, but which hitlessly switches to transmitting the duplicate signal instead. The original signal is accessed at an access location where the original signal is altered. The altered signal is sent to the switching location which again hitlessly switches from transmitting the duplicate signal to transmitting the altered signal.

The present invention can be used in systems where the data signals are carried on carriers. Implementation in an optical network allows wavelengths to be dropped at nodes in the network without network hits being incurred which would disrupt service or otherwise result in system downtime. The provisioning location may be a first node, the access location a second node and the switching location a third node. Hitless switching can be accomplished for two input signals by adjusting the relative delay between the signals using tunable delay elements to compensate for any phase difference or other timing difference, thus allowing a selector or other switching device to switch between the two input signals without generating a hit for downstream users and/or locations.

In some embodiments, an unused wavelength in an optical network is provisioned as the second carrier. Alternately, a wavelength may be reserved for use in reconfiguration and dropping of wavelengths carrying data.

In other embodiments, a network element includes an adjustable selection unit having a signal line for each of a plurality of potentially accessed data signals. Each signal line has a tunable timing element configured to receive a data signal and an output for transmitting the data signal for that line after adjustably delaying the data signal. The output of each timing element becomes a first input to a selector. A provisioned signal connection is a second input to the selector. The provisioned signal may also be passed though a tunable timing element to permit adjustment of its timing relative to the delayed data signal. A controller controls which of the two inputs passes as the selector's output. The network element also has a multicast switch having one input for each selector output and an output for each potentially accessed data signal.

A network element according to one or more embodiments of the present invention can act as a provisioning location, access or alteration location and/or a switching location. In some embodiments, the network element is configured to receive a number of wavelengths in an optical system, with a signal line for each wavelength the network element can drop and access.

In other embodiments, a network segment includes three locations in a data transmission system. A provisioning location is configured to receive an original signal and provision a duplicate of the original signal which is sent to a switching location that is transmitting the original signal. The switching location receives the duplicate signal and hitlessly switches to transmitting the provisioned duplicate signal. Once the switching location has made this first hitless switch, the original signal is accessed at an access location configured to permit alteration of the original data signal. While the original data signal is being altered to create an altered signal, the switching location continues to receive the provisioned duplicate data signal and to transmit that duplicate data signal. Once alteration of the original signal is completed, the altered signal is sent to the switching location. The switching location hitlessly switches from transmitting the provisioned duplicate data signal to transmitting the altered signal. Once this second hitless switch is completed, the provisioning location ceases transmission of the duplicate data signal.

The provisioning location includes signal processing and switching apparatus, such as a multicast switch, to permit duplication of the original data signal and concurrent transmission of the original data signal on the first and second carriers. The access location can include signal processing and switching apparatus, such as one or more add-drop multiplexers, to permit access to the first carrier and the original data signal. The switching location can include signal processing and switching apparatus, such as a hitless switching unit, that allows the switching location to hitlessly switch between the first and second carriers at various times, based on the relative phase differences between the data signals being carried on the first and second carriers. Tunable delay elements and selectors are used in some embodiments to permit hitless switching.

Other aspects and advantages of the present invention will become apparent from the following detailed description, taken in conjunction with the accompanying drawings, illustrating by way of example the principles of the invention.

### BRIEF DESCRIPTIONS OF THE DRAWINGS

The present invention will be readily understood by the following detailed description in conjunction with the accompanying drawings, wherein like reference numerals designate like structural elements, and in which:

FIG. 1A is a schematic diagram of a node utilizing a reconfigurable OADM configured to drop at least one wavelength while allowing another wavelength to pass transparently through the node.

FIG. 1B is a schematic diagram of a node utilizing a reconfigurable OADM configured to drop two wavelengths.

FIGS. 2A-2D are schematic diagrams showing one embodiment of a hitless add-drop technique of the present invention.

FIG. 2E is another schematic diagram showing an embodiment of the hitless add-drop technique of the present invention.

FIG. 3 is a schematic diagram of a tunable delay hitless switching element usable in one or more locations in some embodiments of the present invention.

FIG. 4 is a schematic representation of a node usable in a data transmission system utilizing the present invention.

FIG. 5 is a schematic representation of a node of one embodiment of the present invention used to provision a protection wavelength with the same data as the original signal's wavelength.

FIG. 6 is a schematic representation of a node hitlessly switching data being input to the node on one wavelength to be output on another wavelength.

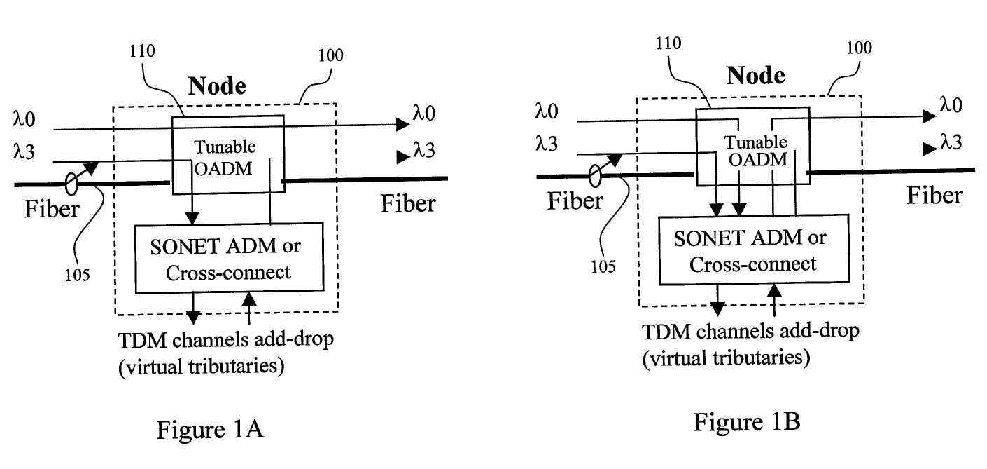

### DETAILED DESCRIPTION OF THE INVENTION

The following detailed description of the invention will be with reference to one or more embodiments of the invention, but is not limited to such embodiments. The detailed description is intended only to be illustrative. Those skilled in the art will readily appreciate that the detailed description given herein with respect to the Figures is provided for explanatory purposes as the invention extends beyond these limited embodiments. For example, the present invention is described in some instances in connection with a SONET system. However, the present invention can be used with other systems that would benefit from the improved performance afforded by the present invention. In addition, the present invention is not limited solely to optical systems and may be used in other environments, such as electrical systems. Consequently, the present invention is not limited solely to optical or SONET based systems.

In particular, the present invention may be implemented using various transmission protocols and various switching/multiplexing protocols. For example, one or more embodiments of the present invention are described below in a network element wherein the transmit protocol is SONET and the switching/multiplexing protocol also is SONET. However, different combinations of a transmission protocol and a switching/multiplexing protocol may be used, including (without limitation) Ethernet+Ethernet (where the network element is an Ethernet box), Ethernet+IP (where the network element is an IP router), SONET+IP (where the network element is an IP router) and SONET+ATM (where the network element is an ATM switch). The present invention is independent of the switching/multiplexing protocol and independent of the transmission protocol. Implementation details may differ from those discussed below in connection with SONET, but those skilled in the art, after reading this disclosure, will be able to implement the present invention with such appropriate changes.

The present invention includes methods, techniques, systems and apparatus which permit access to bandwidth at a fine level of granularity without disrupting service in the transmission system. Such disruptions are referred to as “hits” herein and in some of the art. “Access” is broadly defined and may include (without limitation) such operations as circuit provisioning, monitoring, cross-connecting and routing. Wavelength add-drop multiplexing is a fundamental operation performed by a node in an optical transmission system to enable such access.

The present invention may be applied to a variety of systems and configurations. For purposes of illustration and example, and without limiting the scope of the present invention, one or more embodiments of the present invention will be explained in connection with a group of nodes situated in logical succession in an optical transmission system. As will be appreciated by those skilled in the art, other configurations and topologies may benefit from implementation of the present invention and the claims herein are intended to cover such alternative embodiments. Some of the embodiments of the present invention discussed herein assume that nodes have reconfigurable optical add-drop multiplexers (OADMs) that do not 3R all wavelengths, but instead permit selection of which wavelengths will be dropped and allowing other wavelengths to pass transparently through the OADM and node. This design choice agrees with current and future optical network design. Additionally, add-drops are performed on wavelengths already carrying data and performed without incurring any bit errors on wavelength carrying the data. Once, the wavelength add-drop is performed, and the transceivers synchronized in a hitless manner, access to TDM channels, frames and packets within is hitless. The present invention uses a signaling protocol combined with electrical-memory based hitless switching. This results in an inexpensive and robust solution with minimal changes to current network and node design.

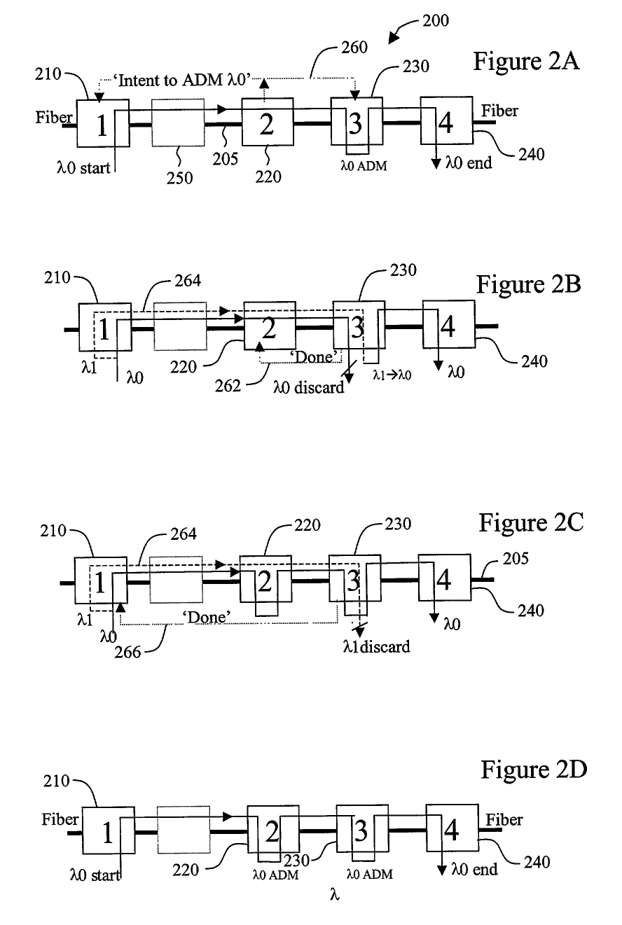

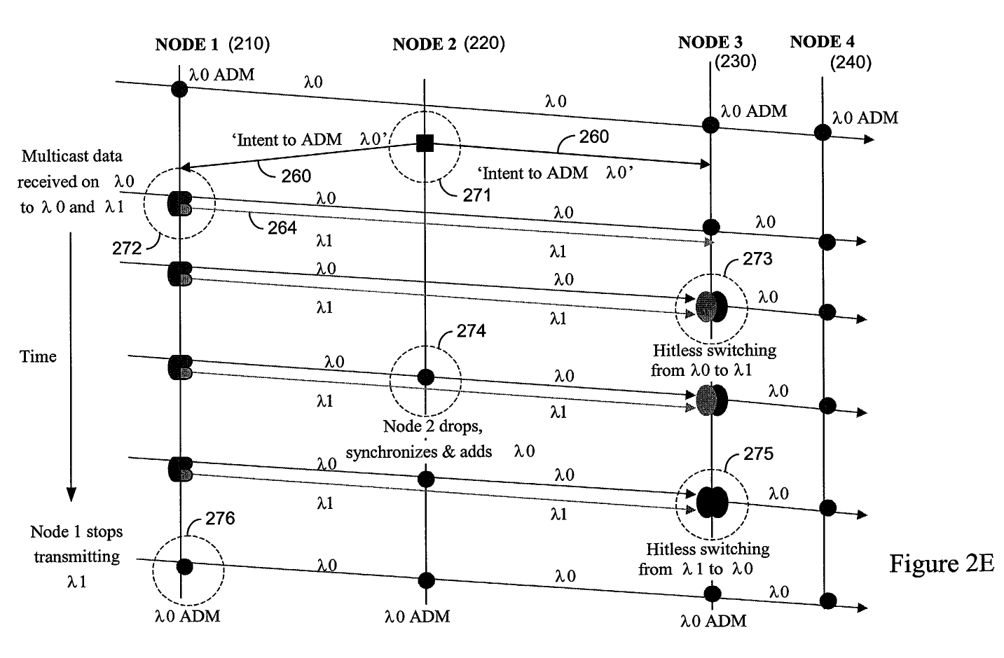

FIGS. 2A-2E illustrate one or more embodiments of the present invention in which an optical system segment 200 possesses a series of nodes 210, 220, 230 and 240 connected by fiber 205. Nodes 210, 220, 230 and 240 can be part of a bigger network and can use a variety of wavelengths, including λ-drop, for data transmission. In this example of the present invention, node 220 lies logically between nodes 210 and 230. Other nodes 250 may be present between nodes 210 and 220 and between nodes 220 and 230 physically, but they are transparent to λ-drop. Moreover, as noted above, the present invention can be implemented independent of network topology (for example, mesh, ring, bus) and independent of the circuit-switched protocol used (for example, SONET, point-to-point Ethernet versions or any other continuous transmission protocol).

Node 220 intends to alter the incoming, original data signal on λ-drop by performing an add-drop on λ-drop. For receivers downstream (for example, nodes 230 and 240), such a wavelength add-drop operation can be considered analogous to a cut at node 220 for λ-drop. Initially, as shown in FIG. 2A, node 220 sends an “Intent to ADM” message 260 to nodes 210 and 230, notifying those nodes that node 220 intends to alter the original data signal being sent on λ-drop. All such messages can be sent between nodes in the present invention using any suitable protocol and/or equipment (for example, a DCC-data communication channel within a SONET frame or a GMPLS control plane).

After this notification, as seen in FIG. 2B, node 210 provisions a second wavelength, λ-protect, by generating λ-protect with the same original data as λ-drop. This provisioning can be accomplished using any suitable means, including the multicast switch described in connection with the detailed description of node configuration below. Node 210 sends λ-protect on a bypass signal 264 that avoids the add-drop operation in node 220. In one embodiment of the present invention, λ-protect passes transparently through node 220 and proceeds to node 230. In other cases, λ-protect may travel to node 230 by a different path (for example, through a different fiber on same path or through a completely different path that passes through a different set of nodes) and/or as a different type of data signal (for example, electrical rather than optical). Node 230 hitlessly switches to receive λ-protect. Node 230 switches its reception from λ-drop to receive the original data now being sent on λ-protect (and ignores the incoming signal on λ-drop). Node 230 continues to transmit the original data signal on λ-drop, hitlessly switching the incoming signal on λ-protect to the transmitter transmitting λ-drop within node 230. Once node 230 has hitlessly switched its reception to λ-protect, node 230 notifies node 220 (sending, for example, a “done” message 262), as shown in FIG. 2B.

As seen in FIG. 2C, after the signal bypass 264 between nodes 210 and 230 is established, node 220 drops λ-drop. Node 220 retimes, regenerates and reshapes (3Rs) λ-drop and outputs λ-drop from node 220 to the fiber 205. Note that throughout the add-drop process at node 220, node 210 is sending the original data signal on λ-protect to node 230 which in turn hitlessly passes that signal on to node 240 on λ-drop. Hence, node 240 and, generally, all nodes other than nodes 210, 220 and 230 are unaware of the protocol being carried out by nodes 210, 220 and 230 in this example. Node 230 discards the signal coming in on λ-drop, which is incurring the hit. Once node 220 has completed the add-drop of λ-drop, node 220 transmits an altered λ-drop signal. As shown in FIG. 2C, once node 230 begins receiving the altered λ-drop signal, node 230 can then hitlessly switch back its reception to λ-drop and discard λ-protect. Node 230 can notify node 210 (for example, by sending a “done” message 266) that node 210 no longer needs to provision λ-protect using the original data signal. As seen in FIG. 2D, node 210 then ceases transmission on λ-protect after receiving notification from node 230. Altered λ-drop is now transmitted from node 220 to 230 and on to other nodes such as node 240 without a hit on the system.

A diagrammatic time progression of the sequence described above is shown in FIG. 2E. As seen in FIG. 2E, λ-drop through nodes 210, 220, 230 and 240. Initially λ-drop passes through node 220 without interference or a drop. At event 271, node 220 multicasts the message 260 to nodes 210 and 230 that node 220 intends to drop λ-drop. At event 272, node 210 provisions λ-protect with a data signal identical to λ-drop and sends that signal to node 230, bypassing or otherwise avoiding interference from node 220. At event 273, node 230 begins receiving λ-protect and transmitting that signal on λ-drop by hitlessly switching between the two wavelengths (that is, node 240 does not see any change in either the signal itself or the wavelength on which it is received). At event 274, node 220 drops, synchronizes and adds λ-drop to its output. After node 220 starts sending the altered λ-drop to node 230, node 230 can then hitlessly switch back to reception of λ-drop at event 275 and continue its output signal on λ-drop, now using the altered signal from node 220 rather than the provisioned original signal on λ-protect. Finally, at event 276, node 210 stops transmitting on λ-protect (for example, after receiving a “Done” message from node 230).

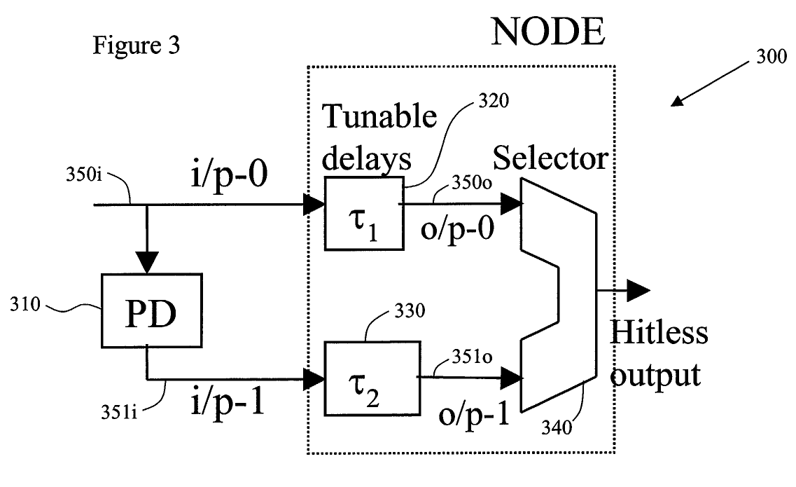

In the embodiment(s) of the present invention described above, node 230 is responsible for hitlessly switching between two inputs—λ-protect and λ-drop. FIG. 3 schematically illustrates one embodiment of a switching element that can be used in such a node. The two wavelengths λ-drop and λ-protect are identical and carry the same data when node 210 initially provisions λ-protect and node 230 performs hitless switching. However, when node 220 has finished performing its add-drop function, node 220 regenerates λ-drop. At this point, λ-drop has been altered (that is, it may carry different data, have a timing difference from its original timing, etc.). Whether or not λ-protect and λ-drop carry the same data, they have a phase difference (PD) relative to one another. This relative difference between signals being input to the node and switching element 300 may be due to various factors (for example, the reconfiguration of λ-drop at node 220, differences in the relative paths traveled by λ-protect and λ-drop before arriving at node 230, or fiber and/or chromatic dispersion due to the difference in propagation speeds of different wavelengths in the fiber).

The two signals λ-protect and λ-drop can be exactly phase-matched in node 230 if an appropriate delay is introduced into one or both of the signals. Once the signals are phase-matched, node 230 can then use either of the two signals (λ-protect or λ-drop) as the node's final output. Further, node 230 can switch back and forth between the two signals without a loss of bits (that is, hitless switching). One embodiment of a signal delay adjustment device 300 for use with the present invention is shown diagrammatically in FIG. 3. The device 300 can be implemented in a variety of ways apparent to those skilled in the art, for example by using random access memory (RAM) and a digital microprocessor. The phase difference PD between the two signals is shown diagrammatically as PD 310.

A first tunable delay unit 320 receives λ-protect input signal 350i from a location such as node 210 (possibly via node 220 without effect) and introduces a first delay τ1 into the λ-protect signal so that the output signal 350o of tunable delay unit 320 is delayed by a selected interval. A second tunable delay unit 330 similarly receives λ-drop as an input signal 351i after delay PD from a location such as node 220 (after incurring a phase difference or delay) and introduces a second delay τ2 so that the output signal 351o of tunable delay unit 330 also is delayed by a selected interval. The delay condition for hitless switching between the output signals 350o and 351o of units 320 and 330, respectively, is τ1=τ2+PD. Note that the phase difference PD is positive when λ-protect leads λ-drop, negative otherwise. Once appropriate delays are tuned, the output signals 350o and 351o can be fed to a selector 340 that chooses which output signal to transmit, and which further can alternate or switch between the two signals as desired.

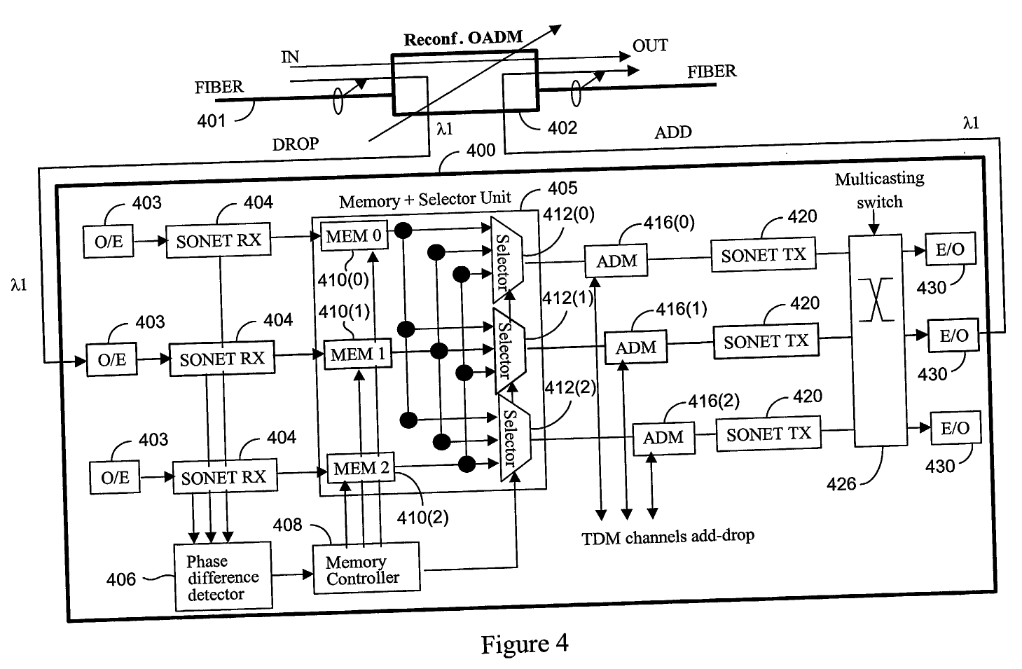

One embodiment of a complete node configuration for use with the present invention is shown diagrammatically in FIG. 4. In FIG. 4, SONET is used as the transmission protocol and the switching/multiplexing protocol for node design and configuration. FIG. 4 shows a reconfigurable optical add-drop multiplexer (OADM) connected to a SONET network element 400 modified to support hitless add-drop multiplexing.

A fiber optic line 401 passes through the OADM 402, which selects one or more wavelengths (or none) to add-drop multiplex at the node 400. Each of the selected signals/wavelengths is input to an optical/electrical converter (O/E) 403 and a SONET receiving unit 404 which condition the signal for add-drop multiplexing in element 400. Information concerning the relative phase differences between input signals also is provided by units 404 to a phase difference detector 406. This phase information is evaluated by a memory controller 408. Again, as noted above, the present invention provides for changes to the network element only. No change to the reconfigurable OADM is needed.

Memory/selector unit 405 includes a RAM memory unit (MEM) 410 for each wavelength line input into unit 405. As will be apparent to those skilled in the art, memory units 410 are capable of adjusting the phase of incoming signals from receiving unit 404 by implementing a tunable/adjustable delay in the signal. These memory units 410 are controlled by controller 408, based at least at times in part on the phase information received and processed by counter 406. After phase adjustment/delay by units 410, if any, wavelength signals are output to a series of selectors 412 in unit 405. In the network element 400 of FIG. 4, each memory unit 410 feeds its output signal to all of the selectors 412. Selectors 412 also are controlled by controller 408. As will be appreciated by those skilled in the art, the selection and arrangement of components in this example could be varied while achieving the same performance and other benefits of the present invention. The configuration shown and described for node 400 is exemplary and is intended to illustrate one or more embodiments of the present invention, without limiting the scope of the present invention in any way.

Based on the instructions from the controller 408, each selector 412 chooses which input signal to pass as its output. The output of each selector 412 is then fed to an add-drop multiplexer (ADM) 416 for each wavelength line. A local tributary interface can provide data to or transport data away from ADMs 416. After add-drop multiplexing is performed at the ADMs 416, a SONET transmitting unit 420 conditions each line's signal. The output of each unit 420 is fed to a multicast switch 426. Each output of multicast switch 426 is then sent to an electrical/optical (E/O) converter 430. These optical wavelength signals are sent back to the OADM for insertion into the traffic on fiber 401.

Using the present invention, network element/node 400 in FIG. 4 may use any free or otherwise available wavelength in the hitless add-drop process (λ-protect in FIG. 2), leading to N degrees of freedom and design complexity. That is, N is the maximum number of wavelengths that a node can add-drop simultaneously. Therefore, a node 400 implementing this embodiment of the present invention would have N RAM memory units 405, N selectors 412 and N add-drop multiplexers 416. Put another way, each node 400 has N carrier/wavelength lines (one for each wavelength that can be dropped simultaneously), each carrier/wavelength line containing a RAM memory unit 405, a selector 412 and an add-drop multiplexer 416. In FIG. 4, for example, if one of the wavelengths entering OADM 402 that can be dropped is λ1, then there is a line available for processing signals carried on λ1. That is, there is an optical/electrical converter 403(1), SONET receiver unit 404(1), memory unit MEM1 410(1), selector 412(1), add-drop multiplexer ADM1 416(1), SONET transmitter unit 420(1) and electrical/optical converter unit 430(1). Multicast switch 426 also has an input for λ1 signals and an output for λ1 signals.

In FIG. 4, to insure the maximum flexibility in selecting λ-protect and phase-matching λ-drop and λ-protect (which may be any two of the N incoming carriers to the node 400), the output of each memory/delay unit 410 is connected to all N selectors. Consequently, each selector 412 needs N inputs. In such a configuration, the phase difference detector 406 is able to detect the phase difference between any two of N signals and, likewise, the controller 408 is able to coordinate such a system.

In an another embodiment of the present invention, a fixed subset of wavelengths is available from which λ-protect is chosen in the network. In a specific case, this subset can be a single wavelength that is reserved in the network to act as λ-protect whenever nodes wants to add-drop another wavelength carrying real data, such as λ-drop. In this case the design of node 400 can be simplified. For example, each selector 412 need have only two inputs, one from the memory unit 410 receiving λ-drop and the other from the memory unit receiving the reserved λ-protect. The phase difference detector 406 needs to detect phase difference only between λ-protect and each one of the (N-1) data channels, which includes λ-drop.

In using a configuration such as the one presented in FIG. 4, the memory units 410 of unit 405 have pre-programmed delay values for any wavelengths used for hitless add-drop processing. Selection of each memory's delay value as a design parameter should preferably be large enough to accommodate the maximum possible phase difference between signals when an upstream location/node wants to perform a hitless add-drop and also needs to be able to absorb the regeneration delay of upstream nodes that might add-drop in the future. Designers can look at the delay programmed into each memory unit 410 and also look at the aggregate delay programmed into a transmission system, network or network segment to permit anticipated future reconfigurations without interruption in service.

As an example, an add-drop can be performed using the node 400 of FIG. 4 and the methodology of FIG. 2. In this example, each node 210, 220, 230 and 240 are duplicates of node 400 in FIG. 4. Further, carrier λ-drop is λ1 in the foregoing example and λ-protect is λ2.

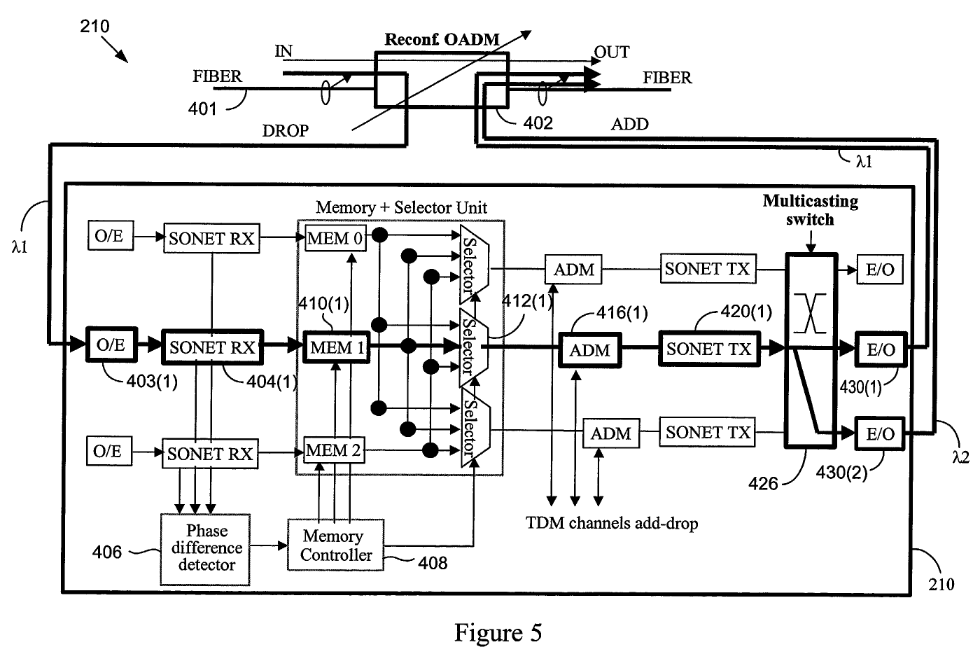

As shown in FIG. 5, λ1 is input to that wavelength's line in node 210. After conversion in unit 403(1) and processing/monitoring by unit 404(1), the signal is input into MEM1 410(1) and, under the control of controller 408, passed to and through selector 412(1). The signal also passes through add-drop multiplexer 416(1) and unit 420(1) to the multicast switch 426, which in turn passes it to E/O 430(1) where the signal is converted to optical form and then added to output fiber 401. After notification from node 220 of its intent to drop λ1, the switch 426 multicasts the signal received on the input line corresponding to λ1 to the output line corresponding to λ2, without interrupting the previous connection inside the switch between the input and output lines corresponding to λ1. Thus there are two identical signals being transmitted on the output lines of switch 426 corresponding to λ1 and λ2. The signal on λ2 is converted from electrical to optical format and placed in the traffic on fiber 401 by E/O unit 430(2). The signal on λ2 passes without interference to node 230 which hitlessly switches to receiving the signal on λ2 (using that line's reception segment in node 230) and transmitting the signal on λ1 after selector 412(1) begins outputting the signal received on the input from MEM2 410(2).

The hitless switching is accomplished using the memory units 410(1) and 410(2), the phase difference detector 406, controller 408 and selector 412(1) in node 230. Again, at this time, the signals received by node 230 on λ1 and λ2 are identical, but are out of phase. When the signal of λ1 leaves MEM1 410(1), it has incurred a delay τ1 at the output of 410(1). The signal being received on λ2 has experienced a delay between its provisioning at node 210 and its arrival at MEM2 410(2) in node 230. This delay may be different than the delay experienced by λ1 which, as noted above, may be the result of various factors. This leads to a phase difference PD between the signals on λ1 and λ2 at node 230. To phase-match the incoming signals corresponding to λ1 and λ2 at selector 412(1), MEM2 410(2) must impose a delay τ2 on the signal arriving on λ2. Phase difference detector 406 in node 230 measures the relative phase difference between the incumbent signal on λ1 and new/provisioned signal on λ2 and provides this information to controller 408. Controller 408 then tunes MEM2 410(2) so that τ1=PD+τ2. If the signal from λ2 is lagging the signal from λ1 (that is, PD is positive), then τ2<τ1; if the signal from λ2 is leading the signal from λ1 (that is, PD is negative), then τ2>τ1. Once the timing of the signals is adjusted so that the signals are phase-matched, controller 408 instructs selector 412(1) to pass as its output of MEM2 410(2) rather than the output of MEM1 410(1) which it had been passing. At this point, the signal on λ1 received at node 230 is discarded and node 220 is notified of the completion of the provisioning and bypass functions via a “done” message from node 230.

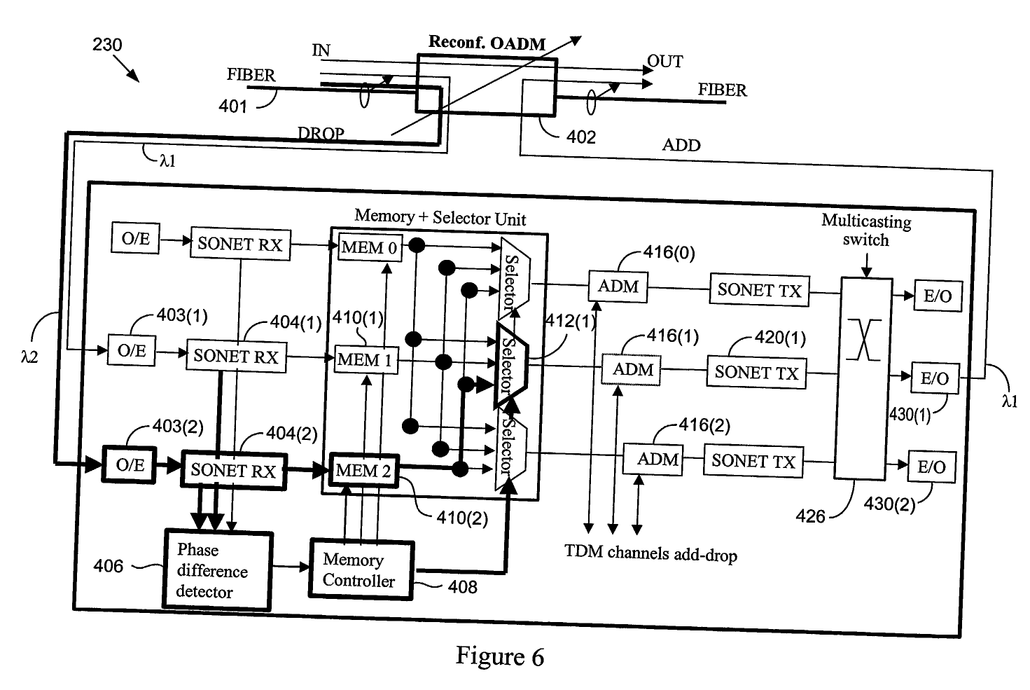

Node 220 now drops λ1 and 3Rs the signal as part of its access of λ1. Node 220 then adds λ1 to the output fiber, sending the signal on λ1 on to node 230. As seen in FIG. 6, node 230 is then receiving the bypass signal on λ2, which is being sent out of node 230 on λ1, and receiving the altered signal on λ1. SONET reception units 404(1) and 404(2) provide phase difference detector 406 with timing information, which is evaluated by controller 408. Analogous to the hitless switching that occurred when the provisioned signal on λ2 first arrived at node 230, node 230 now phase matches the incoming signals from λ1 and λ2. Now, the provisioned signal on λ2 is the incumbent signal. Based on the previous tuning of MEM2 410(2) from the first hitless switching during provisioning, the signal sent on λ2 is still incurring a delay of τ2 while passing through MEM2 410(2). The altered signal of recently dropped λ1 has incurred a delay which, as noted above, may be the result of various factors. This delay creates another phase difference PD* between the signals on λ1 and λ2. Controller 408 sets the delay of MEM1 410(1) to τ1* based on phase difference information provided by detector 406 to compensate for the phase difference between the signals so that the signals leaving memory units MEM1 410(1) and MEM2 (2) are phase-matched. That is, in the case of the second incident of hitless switching (after completion of the add-drop of λ1 at node 220), τ2=PD*+τ1*. Controller 408 also controls the selector 412(1) which now has the two phase-matched signals from MEM1 410(1) and MEM2 410(2) as inputs. Selector 412(1) can then hitlessly switch from the provisioned signal on λ2 to the altered signal of λ1, sending the altered signal on the dropped wavelength λ1 back to fiber 401 on λ1 without the system incurring a hit for the reconfiguration of the λ1 signal at node 220. Once this second hitless switch has been made by node 230, node 230 can send a “done” message to notify node 210 to cease provisioning of λ2. Note that this scheme is independent of OADM design and does not require changes in existing linecard and TDM data switching design. In this way, a signal transmitted on one wavelength or other type of carrier can be hitlessly switched to another wavelength or carrier.

As will be apparent to those skilled in the art, the present invention can be implemented by only 3 nodes: the node intending to add-drop the wavelength (node 220 in FIG. 2) and the two logically adjacent nodes transmitting on the wavelength in question (nodes 210 and 230 in FIG. 2). No other nodes are affected. If functions of two or more nodes in the above examples are combined in a single node, the number of nodes needed for implementation likewise can be reduced. A basic assumption in implementing some embodiments of the present invention is the availability of a free wavelength (λ-protect), albeit temporarily. In some systems, wavelength λ-protect can be reserved for reconfiguration purposes and other control signals. In such a case, the network can permit multiple reconfigurations, as long as the fiber spans do not overlap. Alternately, to enable multiple reconfigurations on the same span, the network could allow any free (unused) wavelength to be used as the temporary protection wavelength λ-protect.

The present invention may also be implemented by involving only nodes 220 and 230 in FIG. 2. To start the operation, node 220 passively receives λ-drop, synchronizes its receiver with the transmitter of node 210, and retransmits the original, received signal from λ-drop on λ-protect. Node 230 then can hitlessly switch from λ-drop to λ-protect. Node 220 then drops and 3Rs λ-drop. Node 230 hitlessly switches back from λ-protect to λ-drop. A disadvantage of this technique is that the node needs a passive tap on the receive-side, which is not common to typical OADM design consisting of AWGs and optical switches.

Generally, embodiments of the present invention employ various processes involving data transferred through one or more computers, microprocessors or similar devices. Embodiments of the present invention also relate to a hardware device or other apparatus for performing these operations. This apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure for a variety of these machines will be apparent to those of ordinary skill in the art based on the present description.

While the present invention is well suited for networks on a large scale, such as optical networks, it can be used for achieving hitless access on small-scale systems as well (for example, inside a network element box, on a electrical circuit board, or within a integrated circuit chip). In such applications, the data signal might not be on a modulated carrier as typically contemplated, but might be on-off modulated stream of data, being sent as bit stream, for example. The claims are intended to cover all of these types of embodiments of the present invention and the terminology used herein is to be interpreted broadly to cover all such embodiments.

In addition, embodiments of the present invention may relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer, microprocessor or similar device using an interpreter.

The many features and advantages of the present invention are apparent from the written description, and thus, the appended claims are intended to cover all such features and advantages of the invention. Further, since numerous modifications and changes will readily occur to those skilled in the art, the present invention is not limited to the exact construction and operation as illustrated and described. Hence, all suitable modifications and equivalents are deemed to fall within the scope of the invention.

We claim:

1. A method of hitlessly accessing an original signal, the method comprising:
provisioning a duplicate signal at a provisioning location, wherein the duplicate signal is a duplicate of the original signal;
sending the duplicate signal to a switching location that is transmitting the original signal;
the switching location switching from transmitting the original signal to transmitting the duplicate signal;
accessing the original signal at an access location;
altering the original signal at the access location to create an altered signal;
sending the altered signal to the switching location;
hitlessly switching from transmitting the duplicate signal to transmitting the altered signal at the switching location.

2. The method of claim 1 wherein:
the original signal is carried on a first carrier and the duplicate signal is carried on a second carrier;
further wherein the step of switching from transmitting the original signal to transmitting the duplicate signal comprises switching from transmitting the original signal on the first carrier to transmitting the duplicate signal on the second carrier; and
further wherein the step of hitlessly switching from transmitting the duplicate signal to the altered signal at the switching location comprises switching from transmitting the duplicate signal on the second carrier to transmitting the altered signal on the first carrier.

3. The method of claim 2 wherein the first carrier is a light wavelength and further wherein the second carrier is a light wavelength.

4. The method of claim 2 wherein the second carrier is a carrier selected from the group of:
a carrier reserved for provisioning within a data transmission system, or
an unused carrier within a data transmission system.

5. The method of claim 1 wherein the step of the switching location switching from transmitting the original signal to transmitting the duplicate signal comprises hitlessly switching from transmitting the original signal to transmitting the duplicate signal prior to accessing the original signal.

6. The method of claim 1 wherein the provisioning location is a provisioning node in an optical data transmission system; further wherein the access location is an access node in an optical data transmission system; and further wherein the switching location is an switching node in an optical data transmission system.

7. The method of claim 1 wherein the step of hitlessly switching from transmitting the duplicate signal to transmitting the altered signal at the switching location comprises delaying one of the duplicate signal or the altered signal to phase-match the duplicate signal and the altered signal.

8. The method of claim 1 wherein the access location notifies the provisioning location and the switching location before accessing the original signal.

9. The method of claim 1 wherein the step of provisioning the duplicate signal is performed at least until the step of hitlessly switching from transmitting the duplicate signal to transmitting the altered signal at the switching location is completed.

10. A method of performing a hitless add-drop on a first wavelength carrying an original signal, the method comprising the steps of:
an add-drop node notifying a provisioning node and a switching node of an upcoming add-drop of the first wavelength, wherein the switching node is receiving the original signal on the first wavelength and transmitting the original signal on the first wavelength;
the provisioning node provisioning a second wavelength to carry the original signal between the provisioning node and the switching node;
the switching node hitlessly switching from transmitting the original signal on the first wavelength to transmitting the original signal on the second wavelength;
dropping the first wavelength at the add-drop node;
altering the original signal to create an altered signal;
transmitting the altered signal on the first wavelength from the add-drop node to the switching node;
the switching node hitlessly switching from transmitting the original signal on the second wavelength to transmitting the altered signal on the first wavelength; and
the provisioning node ceasing provisioning of the second wavelength.

11. The method of claim 10 wherein the step of the switching node hitlessly switching from transmitting the original signal on the second wavelength to transmitting the altered signal on the first wavelength comprises delaying at least one of the first and second wavelengths to phase-match the original signal and the altered signal.
